(19) United States
(12) Patent Application Publication
(10) Pub. No.: US 2008/0247716 A1
(43) Pub. Date: Oct. 9, 2008

(54) Electooptical Communications and Power Cable

(76) Inventors: Rytz Thomas, Glattbrugg (CH); Martin Rutschi, Burgdorf (CH)

Correspondence Address: BACHMAN & LAPOINTE, P.C., 900 CHAPEL STREET, SUITE 1201, NEW HAVEN, CT, 06510, US

(21) Appl. No.: 11/989,079

(22) PCT Filed: Jul. 7, 2006
(86) PCT No.: PCT/CH2006/000361

§ 371 Date: Jun. 23, 2008

(30) Foreign Application Priority Data
Jul. 14, 2005 (CH) 1169/05

(51) Int. Cl. H01B 11/22

(52) U.S. Cl. 385/101

(57) ABSTRACT

An electrooptical communications and power cable has at least one light waveguide, which is arranged in a central multifibre bundle consisting of a smooth flexible metal tube and provided with a primary jacket. Two layers of stranded metal wires are extended coaxially to the multifibre bundle. The metal wires are also used for relieving a traction and/or transversal load. The internal metal wire layer consists of metal wires exhibiting a good electric conductivity. The external metal wire layer has metal wires which are arranged alternately individually and/or group groupwisely and exhibit a good electrical conductivity and metal wires exhibiting a high traction strength. The two wire layers are held at a distance (a) from each other by an insulating layer. The communications and power cable is used first of all for an electrooptical power connection between two voltage converters in an intelligent system.

### BACKGROUND

(1) Field of the Invention

The invention relates to an electrooptical communications and power cable, which comprises, in a central bundle core comprising a smooth, flexible metal tube, at least one optical waveguide with a primary sheathing, two layers running coaxially with respect to the bundle core and comprising stranded metal wires, which are also used as relief from tensile and/or transverse forces, and an outer sheath. Furthermore, the invention relates to a use for the electrooptical communications and power cable.

(2) Prior Art

Optical cables with optical waveguides, in particular optical fibers, have been known for many decades. The data are transmitted not in the form of electrical pulses through metal conductors but as light quanta in optical waveguides. Interfaces are electrooptical couplings, which convert electrical pulses into light quanta, and vice versa.

Modern optical waveguides and optical communications and power cables with at least one optical waveguide are known, for example, from the company publication “Kommunikationskabel/Communication Cables” by Brugg Kabel AG, CH-5201 Brugg, revised edition 2004.

An optical waveguide of the known type comprises an optical core and an optical sheath, in practice an optical fiber with an outer sheath of in total approximately 125 μm in diameter. A primary sheathing of the optical fibers made from a plastic has an outer diameter of 250 μm, for example. Depending on the use, cables with single-mode fibers or multi-mode fibers are used; further details are given in the previously mentioned company publication, pages 6-9.

Electrooptical cables comprise, in addition to at least one optical waveguide, electrical conductors which are used, for example, for supplying voltage or for transmitting electrical signals. The electrical conductors are arranged on the optical cable or connected to it. Electrooptical communications and power cables are also known as hybrid cables.

If the bundle core comprises a metal tube having a high electrical conductivity, this metal tube itself can be used as the electrical conductor. Conventional steel tubes are not very suitable or not suitable at all for this purpose owing to the low electrical conductivity, however.

It is known from EP 0816885 B1 and DE 4236608 A1 to strand a bundle core with optical conductors with at least one metallic armoring layer. As a result, firstly the tensile force is increased and secondly the bundle core is better protected against transverse forces.

EP 0371660 A1 has described an electrooptical cable, which comprises a central bundle core with a thin steel tube. This thin steel tube is surrounded by a dielectric layer, in which copper litz wires having a high electrical conductivity are embedded. A two-layered armor comprising steel wires is arranged outside the dielectric layer. For their part these steel wires are embedded in the protective sheathing.

### SUMMARY OF THE INVENTION

The invention is based on the object of further improving an electrooptical cable of the type mentioned at the outset and extending its field of use.

The object is achieved according to the invention by virtue of the fact that the inner wire layer comprises electrically highly conductive metal wires, and the outer wire layer comprising metal wires arranged in alternating fashion individually and/or in groups and having a high electrical conductivity, on the one hand, and metal wires having a high tensile strength, on the other hand, are held at a distance by means of an insulating layer. Specific and further-reaching embodiments of the electrical communications and power cable are the subject matter of dependent patent claims.

Here and in the text which follows the term “metal wires” also includes metal litz wires with comparable electrical and mechanical properties. In electrooptical communications and power cables, the signals are transmitted optically, and possibly even electrically if necessary, and the power is transmitted exclusively electrically.

Metals with an electrical resistivity of at most 5×10⁻⁵Ω.mm, in particular (1−3)×10⁻⁵Ω.mm, are preferably used as the electrically highly conductive metal wires. Taking into consideration the material costs, in particular copper, copper alloys, aluminum and aluminum alloys fall into this group. It is naturally also possible for composite wires coated with one of these electrically highly conductive metals, in particular with a steel core, to be used.

The electrically less conductive, outer metal wires have a high tensile strength of at least approximately 700 N/mm; wires made from a stainless steel are particularly well suited.

The alternating arrangement of the two different metal wires of the outer wire layer can take place in a wide variety of ways; for reasons of simplicity the electrically highly conductive wires are denoted by Cu, and the wires with high tensile strength are denoted by Fe, for example

. . . Fe.Cu.Fe.Cu.Fe.Cu . . .

. . . Fe.Fe.Cu.Cu.Fe.Fe.Cu.Cu . . .

. . . Fe.Fe.Cu.Fe.Cu.Fe.Fe.Cu . . .

. . . Cu.Cu.Fe.Cu.Cu.Fe.Cu.Cu.Fe . . .

. . . Fe.Fe.Cu.Fe.Cu.Fe.Cu.Fe . . .

. . . Fe.Fe.Fe.Cu.Fe.Cu.Fe.Cu.Fe.Cu.Fe.Fe.Fe.Fe.Cu.Fe . . .

The inner and the outer wire layer preferably have the same ohmic resistance.

The alternating of the metal wires individually and/or in groups can therefore be regular or irregular. The greater the proportion of Fe wires is, the lower is the electrical transport power of the outer wire layer. Given a higher proportion of Fe wires in the outer wire layer, the relief from tensile and transverse forces is markedly improved.

The metal wires having a high tensile strength of the outer layer (Fe wires) and the metal tube of the bundle core are expediently made from the same material, namely a stainless steel.

The electrically highly conductive metal wires (Cu wires) of the inner layer preferably rest directly on the metal tube of the bundle core. If the metal tube of the bundle core is made from an electrically highly conductive metal, the metal wires of the inner layer can be replaced by a metal tube with a corresponding wall thickness.

In particular for reasons of fabrication, in general all the metal wires have the same diameter. Depending on the use, this diameter can extend from the fine wire to the bulky wire of approximately 1 mm. For general use, the wire diameter is usually in the range of from 0.3 to 0.5 mm.

The thickness of the insulating layer separating the inner and the outer wire layer is at least the average radius, preferably at least the average diameter of the metal wires or the stranded litz wires.

The insulating layer is expediently made from a dielectric plastic, in particular polyethylene or polypropylene. The outer sheath can be made from the same material or from polyurethane, polyamide or FRNC; it is used for mechanical and chemical protection; the outer surface is preferably capable of being partially printed easily.

Furthermore, a swelling strip can be arranged between the wire layer and the outer sheath and/or a moisture barrier can be arranged outside the outer wire layer. This barrier is preferably an aluminum foil or an aluminum/plastic laminate of a type known per se.

By way of summary, the following advantages result for the electrooptical communications and power cable according to the invention:
A bundle core comprising a metal tube, an inner wire layer comprising electrically highly conductive metal wires and an outer wire layer comprising metal wires arranged in alternating fashion individually and/or in groups and having a high electrical conductivity, on the one hand, and metal wires having a high tensile strength, on the other hand, also ensure optimum protection of the optical waveguides against tensile and transverse forces. The electrical conductors are positioned in optimum fashion; on the inside exclusively highly conductive metal wires, and on the outside, in addition to the highly conductive metal wires connected in parallel, also less conductive metal wires having a high mechanical tensile strength nevertheless allow for a high electrical power. The coaxial design of the electrical conductors eliminates the AC losses in the cable.
The electrooptical communications and power cables can in practice always be laid directly, for example underwater, in particular in open bodies of water and in waste water channels in built-up areas and of trade and industry, in the ground, in particular along roads or rail tracks, in pipe systems and cable ducts in buildings. The cable is particularly suitable for use in military tactical systems.
A smooth, flexible metal tube as the bundle core with two wire layers held coaxially at a distance allows for a small bending radius.
Continuous operation can be maintained in a temperature range of from −40 to +80° C. without the power or signal transmission being impaired.

A particularly advantageous use of the communications and power cable as an electrooptical power link between two voltage converters over a distance of up to approximately 20 kilometers. One of the two voltage converters is generally permanently wired, and the other voltage converter is controllable. Voltage converters are, for example, transformers or switched mode power supplies. Of interest here is an intelligent system with a microcomputer.

### BRIEF DESCRIPTION OF THE DRAWINGS

The invention will be explained in more detail with reference to exemplary embodiments which are also the subject matter of dependant patent claims and which are illustrated in the drawing, in which, schematically:

FIG. 1 shows a perspective view of a graduated, front-side end of an optical waveguide (prior art),

FIG. 2 shows a cross section through a bundle core with a metal tube (prior art),

FIG. 3 shows a cross section through an electrooptical communications and power cable, and

FIG. 4 shows a diagram of a use of an electrooptical communications and power cable.

### DETAILED DESCRIPTION OF THE PREFERRED EMBODIMENT(S)

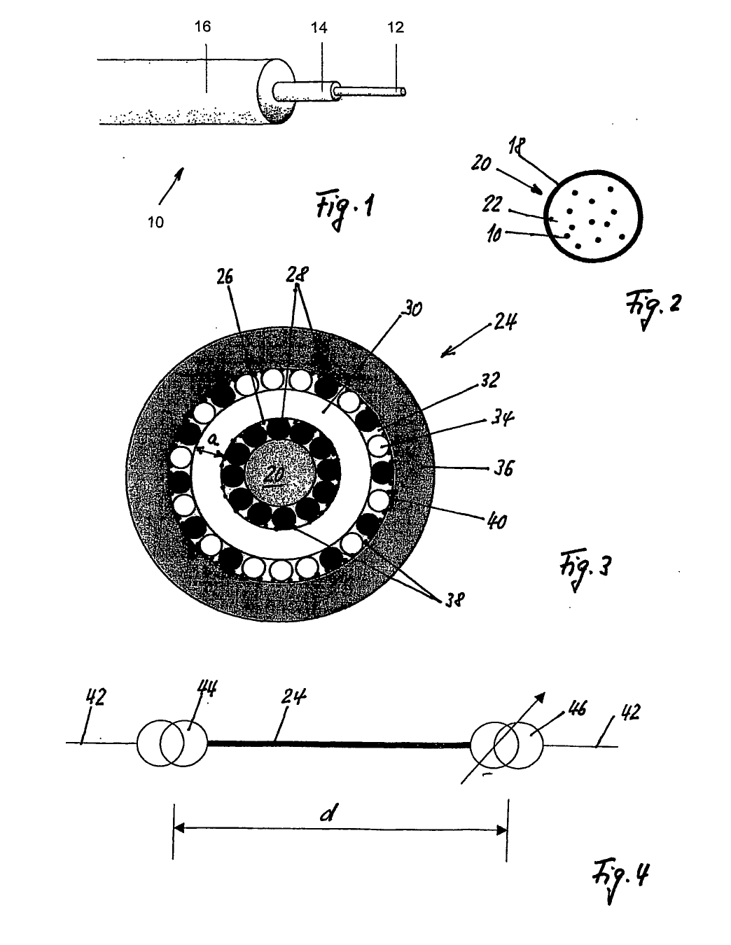

FIG. 1 shows an optical waveguide 10 with an optical core 12 and an optical sheath 14 made from glass and a primary sheathing 16 made from plastic. The optical core 12 and the optical sheath 14, corresponding to their usual material, are also referred to as optical fibers for reasons of simplicity. A distinction is drawn between single-mode fibers and multi-mode fibers, which is irrelevant here and cannot be seen in FIG. 1 for reasons of simplicity.

FIG. 2 shows a bundle core 20 with a metal tube 18 made from a stainless steel, twelve optical waveguides 10, which are arranged so as to run longitudinally therein, as shown in FIG. 1. The bundle core 20 is filled with a core filling compound 22, in this case with a gel.

In an electrooptical communications and power cable 24 as shown in FIG. 3, a bundle core 20 as shown in FIG. 2 is arranged in the center. The metal tube 18 of the bundle core 20 is stranded in direct contact with an inner, single-layered wire layer 26, which comprises twelve copper wires 28. An insulating layer 30 made from polyethylene is extruded onto this inner wire layer 26, which insulating layer 30 has a greater thickness a than the diameter of the copper wires 28.

The insulating layer 30 is stranded with an outer wire layer 32, which in turn is designed to have a single layer. Electrically highly conductive wires 28 are arranged in alternating fashion individually and in groups with wires 34 having a high tensile strength, in this case stainless steel wires. The arrangement along the circumference is irregular; in each case one copper wire 28 is replaced by a stainless steel wire 34 at the bottom and top. As a result, the electrical conductivity of the entire communications and power cable 24 is slightly reduced in favor of mechanical strength. As has already been mentioned, any desired combinations between copper wires 28 and stainless steel wires 34 can be arranged.

The copper wires 28 of the inner and outer wire layer 26, 32 are connected in parallel. Preferably, the two wire layers 26, 32 have the same ohmic resistance; in other words they are designed to be symmetrical.

An outer sheath 36 made from polyurethane protects the communications and power cable 24 mechanically and chemically; it also allows for printing.

Both the wires 28 of the inner wire layer 26 and the wires 28, 34 of the outer wire layer 32 are held together with a retaining strip or net 38 and therefore remain positioned in the correct position during the production process. The retaining strip is in this case a Melinex strip by DuPont.

A moisture barrier 40, in this case an aluminum/plastic laminate, only partially illustrated, is optionally arranged between the outer wire layer 32 and the outer sheath 36.

In accordance with a variant not shown, a swelling strip can be arranged between the outer wire layer 32 and the outer sheath 36, within a moisture barrier 40 which is in any case present, which swelling strip swells on the ingress of moisture and exerts a pressure on all the layers, which pressure prevents the moisture from pushing forwards in the longitudinal direction or at least severely restricts this.

In accordance with the use illustrated in FIG. 4, an electrooptical communications and power cable 24 is used as a transmission line for remotely feeding a system with an operational voltage of 110 V/60 Hz or 230 V/50 Hz at a distance of up to 20 km. A primary-side voltage converter 44 sets the fed-in voltage of 110 V/60 Hz or 230 V/50 Hz to a voltage level of 100-1000 VAC or 100-1500 VDC.

The secondary-side converter 46 regulates the transmission voltage of 100-1000 VAC or 100-1500 VDC back to the conventional system voltages of 110 V/60 Hz or 230 V/50 Hz.

The voltage converter 44 is equipped with a standby mode. This standby mode disconnects the voltage in the power cable 24 if no load is present at the voltage converter 46.

### EXAMPLE

Electrooptical communications and power cable Electrically highly conductive copper wires 28 and stainless steel wires 34, with a diameter of 0.40 and 0.42 mm, respectively, are stranded in accordance with the invention. The arrangement in the communications and power cable corresponds to FIG. 3, in particular also the sequence of the copper wires 28 and stainless steel wires 34. These wires are separated from one another by means of a PE insulating layer 30 which is 0.6 mm thick (thickness a). The outer protection is ensured by an outer sheath 36 comprising a polyurethane layer which is 0.8 mm thick. The inner and the outer wire layer 26, 34 are covered by a Melinex strip. The communications and power cable 24 has an outer diameter of 5.8 mm, weighs 68 kg/m and has a total conductor cross section of the copper cables of approximately 1.5 mm².

Electrical conductivity

δ_{Cu}=0.0172(Ω.mm²)/m

δ_{stainless steel}=0.4129(Ω.mm²)/m.

Resistances per km and per wire

Cu wire: cross section=0.1257 mm²; this corresponds to a resistance R_{Cu} of 136.8Ω/km.

Stainless steel wire: cross section=0.1385 mm²; this corresponds to a resistance R_{stainless steel} of 1031.5Ω/km.

Resistance of the entire wire layers per km

Conductors of the inner wire layer 26: twelve copper wires; this corresponds to a resistance Rᵢ of 11.4Ω/km.

Conductors of the outer wire layer 32: ten copper wires; this corresponds to a resistance Rₐ of 12.45Ω/km.

The resistance of the copper wires 28 connected in parallel of the inner and outer wire layers 26, 32 corresponds to a conductor resistance of R=(12.45×73.7)/(12.45+73.7)=11.53Ω/km.

A cable having a conventional diameter withstands, for example, a continuous tensile loading of approximately 3000 N and a transverse-pressure loading of approximately 1000 N/cm without in the process the function being impaired. The cable breakage in this case takes place only at approximately 4250 N.

1.-11. (canceled)

12. An electrooptical communications and power cable, which comprises, in a central bundle core comprising a smooth, flexible metal tube, at least one optical waveguide with a primary sheathing, two layers running coaxially with respect to the bundle core and comprising stranded metal wires, which are also used as relief from tensile and/or transverse forces, and an outer sheath, said two layers including an inner wire layer comprising electrically highly conductive metal wires, and an outer wire layer comprising first metal wires arranged in alternating fashion individually and/or in groups and having a high electrical conductivity, on the one hand, and second metal wires having a high tensile strength, on the other hand, held at a distance (a) by means of an insulating layer.

13. The communications and power cable as claimed in claim 12, wherein the electrically highly conductive first metal wires, are connected in parallel and have an electrical resistivity of at most approximately 5×10⁻⁵Ω.mm, and the second metal wires have a tensile strength of approximately 700 N/mm.

14. The communications and power cable as claimed in claim 13, wherein the electrical resistivity is in the range of from 1×10⁻⁵ Ω.mm to 3×10⁻⁵Ω.mm.

15. The communications and power cable as claimed in claim 13, wherein the electrically highly conductive first metal wires are made from a metal selected from the group consisting of copper, a copper alloy, aluminum and an aluminum alloy or are coated with a metal selected from the group consisting of copper, a copper alloy, aluminum and an aluminum alloy, the second metal wires having a high tensile strength are made from a stainless steel.

16. The communications and power cable as claimed in claim 13, wherein the second metal wires are made from the same metal as the metal tube of the bundle core.

17. The communications and power cable as claimed in claim 12, wherein the inner wire layer rests directly on the metal tube.

18. The communications and power cable as claimed in claim 12, wherein the inner wire layer is replaced by the metal tube.

19. The communications and power cable as claimed in claim 12, wherein all of the first and second metal wires have the same diameter.

20. The communications and power cable as claimed in claim 12, wherein the insulating layer separating the wire layers has a thickness which corresponds at least to an average radius, of the first and second metal wires.

21. The communications and power cable as claimed in claim 19, wherein said thickness corresponds to at least an average diameter of the first and second metal wires.

22. The communications and power cable as claimed in claim 12, wherein the insulating layer is made from one of polyethylene and polypropylene, and the outer sheath is made from one of polyurethane and the same material as the insulating layer.

23. The communications and power cable as claimed in claim 12, wherein the two wire layers have approximately the same ohmic resistance, are designed to be symmetrical, and are covered by one retaining strip or net.

24. The communications and power cable as claimed in claim 12, further comprising a swelling strip arranged between the outer wire layer and the outer sheath and a moisture barrier formed from one of an aluminum foil and an aluminum/plastic laminate, arranged outside the outer wire layer.

25. The communications and power cable as claimed in claim 12, wherein said cable comprises an electrooptical power link between two voltage converters in an intelligent system.

26. The communications and power cable as claimed in claim 24, wherein said cable is used as a power link between a permanently wired converter and a controllable voltage converter over a distance of up to approximately 20 km.

27. The communications and power cable as claimed in claim 24, wherein the cable transmits electrical energy in a power link with a 50 Hz or 60 Hz AC voltage of 100-1000 VAC or a DC voltage of 100-1500 VDC.
